(19) United States
(12) Patent Application Publication
(10) Pub. No.: US 2025/0206083 A1
(43) Pub. Date: Jun. 26, 2025

(54) CONTAINER WITH FUNCTIONAL COMPONENT, AND TIRE

(71) Applicant: THE YOKOHAMA RUBBER CO., LTD., Kanagawa (JP)

(72) Inventor: Takahiro SUZUKI, Kanagawa (JP)

(21) Appl. No.: 18/848,368

(22) PCT Filed: Mar. 16, 2023
(86) PCT No.: PCT/JP2023/010332

§ 371 Date: Sep. 18, 2024

(30) Foreign Application Priority Data
Mar. 23, 2022 (JP) 2022-047065

(51) Int. Cl. B60C 23/04; B60C 19/00

(52) U.S. Cl. CPC B60C 23/0493; B60C 2019/004

(57) ABSTRACT

A housing body with a functional component includes a functional component configured to acquire tire information and a housing body adapted to house the functional component. The functional component includes a housing containing an electronic component, and a piezoelectric element having a film-shape and being fixed to a wall surface of the housing. At least one projection is formed on an inner surface of the housing body, and at least a part of the projection and the piezoelectric element are directly in contact with each other or indirectly in contact with each other via the wall surface of the housing in an unloaded state and in a state where the functional component is housed in the housing body.

### TECHNICAL FIELD

The present technology relates to a housing body with a functional component and a tire, and particularly relates to a housing body with a functional component and a tire that enable the functional component to accurately acquire tire internal information by devising an internal shape of the housing body housing the functional component.

### BACKGROUND ART

A functional component (for example, a sensor unit including a sensor) configured to acquire tire internal information such as internal pressure or temperature is installed on a tire inner surface (see, for example, Japan Patent No. 6272225 B and Japan Unexamined Patent Publication No. 2016-505438 T). In installing the functional component, a housing body (container) made of rubber or the like is adhered to the tire inner surface, and the functional component is housed inside the adhered housing body. For example, when the functional component includes a piezoelectric element attached to a wall surface of the housing, there is a problem that the functional component may be unable to accurately acquire the tire internal information because, due to the curvature of the tire inner surface or recesses/protrusions caused by bladders or due to up-down movement caused by an impact from tire rolling, the piezoelectric element does not sufficiently come into contact with an inner surface of the housing body and the sensing output of the piezoelectric element is thus not stable.

### SUMMARY

The present technology provides a housing body with a functional component and a tire that enable the functional component to accurately acquire tire internal information by devising an internal shape of the housing body housing the functional component.

A housing body with a functional component according to an aspect of the present technology includes: a functional component configured to acquire tire information; and a housing body adapted to house the functional component. The functional component includes a housing containing an electronic component, and a piezoelectric element having a film-shape and being fixed to a wall surface of the housing. At least one projection is formed on an inner surface of the housing body, and at least a part of the projection and the piezoelectric element are directly in contact with each other or indirectly in contact with each other via the wall surface of the housing in an unloaded state and in a state where the functional component is housed in the housing body.

In addition, a tire according to an aspect of the present technology includes the aforementioned housing body with a functional component fixed to a tire inner surface, the functional component being housed in the housing body.

According to an aspect of the present technology, the housing body with a functional component includes: the functional component configured to acquire tire information; and the housing body adapted to house the functional component. The functional component includes a housing containing the electronic component, and a piezoelectric element having a film-shape and being fixed to the wall surface of the housing, at least one projection is formed on an inner surface of the housing body, and at least a part of the projection and the piezoelectric element are directly in contact with each other or indirectly in contact with each other via the wall surface of the housing in an unloaded state and in a state where the functional component is housed in the housing body. As a result, a pressed state of the projection against the piezoelectric element by vibration of the tire during travel is held, which enables stable sensing by the piezoelectric element. Accordingly, the functional component can accurately acquire the tire internal information without influence by the curvature of the tire inner surface or recesses/protrusions due to bladders.

In the housing body with a functional component according to an aspect of the present technology, a contact area between the projection and the piezoelectric element is preferably 50% or less with respect to an area of the inner surface of the housing body on which the projection is formed, and is preferably 10% to 100% with respect to a surface area of a pressure sensing portion of the piezoelectric element. Accordingly, the contact area between the projection and the piezoelectric element is sufficiently ensured, and the contact state between the projection and the piezoelectric element is favorably maintained, which contributes to stable sensing by the piezoelectric element.

A height of the projection from the inner surface of the housing body on which the projection is formed is preferably 0.1 mm to 2.0 mm. Accordingly, the contact state between the projection and the piezoelectric element can be appropriately maintained. In addition, the functional component can be prevented from falling off during travel without influence on an operation for housing the functional component in the housing body.

The projection is preferably made of vulcanized rubber having a modulus at 100% elongation of 1.0 MPa or more and less than 12.0 MPa. Accordingly, the durability of the housing body and ease of housing the functional component in the housing body can be provided in a compatible manner.

The housing body preferably includes a bottom portion fixed to a tire inner surface, a crown portion protruding from the bottom portion, a housing space formed by the bottom portion and the crown portion, and an opening portion communicating with the housing space. An inclination angle of the crown portion with respect to the bottom portion measured on an outer wall side of the crown portion in a state where the functional component is housed in the housing space is preferably smaller than an inclination angle of the crown portion with respect to the bottom portion measured on the outer wall side of the crown portion in a state where the functional component is not housed in the housing space. An angle difference between the inclination angles is preferably in a range of 5° to 15°. Accordingly, in the housing body housing the functional component, excessive deformation of the housing body can be prevented while ensuring the restricting force by which the functional component can be sufficiently restricted. In particular, when the angle difference between the inclination angles before and after the functional component is housed is in the range of 5° to 15°, the restricting force of the housing body with respect to the functional component and the degree of deformation at which the housing body is not damaged are extremely well-balanced. As a result, the housing body can be prevented from being damaged while preventing the functional component from falling off during travel.

The inclination angle of the crown portion with respect to the bottom portion measured on the outer wall side of the crown portion in a state where the functional component is housed in the housing space is preferably 90° or more. Accordingly, stress concentration at the base of the crown portion of the housing body can be mitigated, and the durability of the housing body can be improved. Further, the opening portion of the housing body is not excessively narrow, which is suitable in removing the functional component.

A thickness Ga of the crown portion in a state where the functional component is housed in the housing space is preferably 1.0 mm to 3.5 mm. Accordingly, the occurrence of cracks in the crown portion of the housing body can suppressed, and the durability of the housing body can be improved. Furthermore, when the thickness of the crown portion of the housing body is excessively large, the heat generation of the housing body increases. However, when the thickness Ga is within the range described above, the heat generation of the housing body can be suppressed, and damage of the housing of the functional component can be prevented.

A width of the opening portion is preferably smaller than a minimum width of the housing space, and a circumferential length D2ᵤ of an upper portion of the housing space and a circumferential length D1ᵤ of an upper portion of the functional component preferably satisfy a relationship 0.60≤D2ᵤ/D1ᵤ≤0.95. Accordingly, the restricting force of the housing body with respect to the functional component can be increased, and the motion of the functional component can be suppressed. Thus, the housing of the functional component can be prevented from being damaged during high-speed travel. In addition, a good balance between the restricting force of the housing body with respect to the functional component and the degree of deformation at which the housing body is not damaged is provided, and thus damage of the housing body can also be prevented.

An end portion of the crown portion preferably includes a locking portion bent toward the opening portion, and a height H1 of the functional component and a total inner height H2 of the housing body preferably satisfy a relationship 0.85≤H2/H1≤0.98. This provides a good balance between the restricting force of the housing body with respect to the functional component and the degree of deformation at which the housing body is not damaged and can improve the durability of the functional component during high-speed travel.

A circumferential length D2_{O} of the opening portion of the housing body and a circumferential length D1ᵤ of an upper portion of the functional component preferably satisfy a relationship 0.4≤D₂O/D1ᵤ≤0.8. This provides a good balance between the restricting force of the housing body with respect to the functional component and the degree of deformation at which the housing body is not damaged and can improve the durability of the functional component during high-speed travel. Further, the opening portion of the housing body is not excessively narrow, which is suitable in removing the functional component.

A modulus of the housing body at 100% elongation at 20° C. is preferably 0.5 MPa or more and less than 10.0 MPa, and a loss modulus of the housing body at 60° C. is preferably 0.4 MPa or more and less than 20.0 MPa. Appropriately setting the modulus as just described can provide the durability of the housing body and ease of housing the functional component in the housing body in a compatible manner. By appropriately setting the loss modulus as just described, the housing of the functional component can be prevented from being damaged due to rubbing of the functional component against the housing body or repeated deformation of the housing body.

The housing body is preferably made of vulcanized rubber. The housing body is preferably fixed to the tire inner surface with an adhesive.

The tire according to an embodiment of the present technology is preferably a pneumatic tire but may be a non-pneumatic tire. In a case of a pneumatic tire, the interior thereof can be filled with any gas including air and inert gas such as nitrogen.

### BRIEF DESCRIPTION OF DRAWINGS

FIG. 1 is a meridian cross-sectional view illustrating an embodiment of a pneumatic tire in which a housing body with a functional component is fixed to a tire inner surface.

FIGS. 2A to 2C illustrate an embodiment of the housing body with a functional component, FIG. 2A is a cross-sectional view of the entire housing body, and FIGS. 2B and 2C are each a cross-sectional view of a main part of the housing body.

FIGS. 3A to 3D illustrate an embodiment of the housing body with a functional component before and after the functional component is housed. FIG. 3A is a perspective view illustrating a state where the functional component is not housed, FIG. 3B is a cross-sectional view illustrating a state where the functional component is not housed, FIG. 3C is a perspective view illustrating a state where the functional component is housed, and FIG. 3D is a cross-sectional view illustrating a state where the functional component is housed.

FIGS. 4A to 4C are half cross-sectional views of the housing body with a functional component for describing the dimensions of the housing body.

FIG. 5 is an explanatory diagram for describing the dimensions of a projection of the housing body in a test tire.

### DETAILED DESCRIPTION

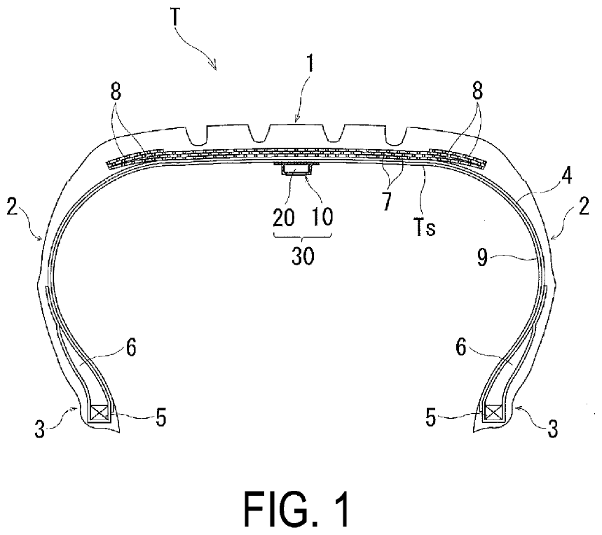

A pneumatic tire according to embodiments of the present technology will be described below in detail with reference to the accompanying drawings. FIG. 1 illustrates a pneumatic tire in which a housing body with a functional component is fixed to a tire inner surface.

As illustrated in FIG. 1, a pneumatic tire T includes a tread portion 1 extending in a tire circumferential direction and having an annular shape, a pair of sidewall portions 2 disposed on both sides of the tread portion 1, and a pair of bead portions 3 disposed on an inner side of the sidewall portions 2 in a tire radial direction.

A carcass layer 4 is mounted between the pair of bead portions 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and formed of a rubber composition is disposed on the outer circumference of the bead core 5. In addition, an innerliner layer 9 is disposed in an area between the pair of bead portions 3 on a tire inner surface Ts. The innerliner layer 9 forms the tire inner surface Ts.

On the other hand, a plurality of belt layers 7 is embedded on the outer circumferential side of the carcass layer 4 in the tread portion 1. The belt layers 7 include a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall in a range from 10° to 40°, for example. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, but the pneumatic tire is not limited thereto.

In the pneumatic tire described above, at least one housing body with a functional component 30 is attached to the tire inner surface Ts. The housing body with a functional component 30 can be attached to any portion of the tire inner surface Ts. However, the housing body with a functional component 30 is preferably attached to the tire inner surface Ts corresponding, in particular, to the tread portion 1 because the housing body with a functional component 30 is less deformed during travel and is unlikely to come off due to centrifugal force applied thereto. The housing body with a functional component 30 includes a functional component 20 configured to acquire tire information and a housing body 10 housing the functional component 20. The housing body with a functional component 30 is fixed to the tire inner surface Ts with an adhesive layer formed of, for example, an adhesive or double-sided tape.

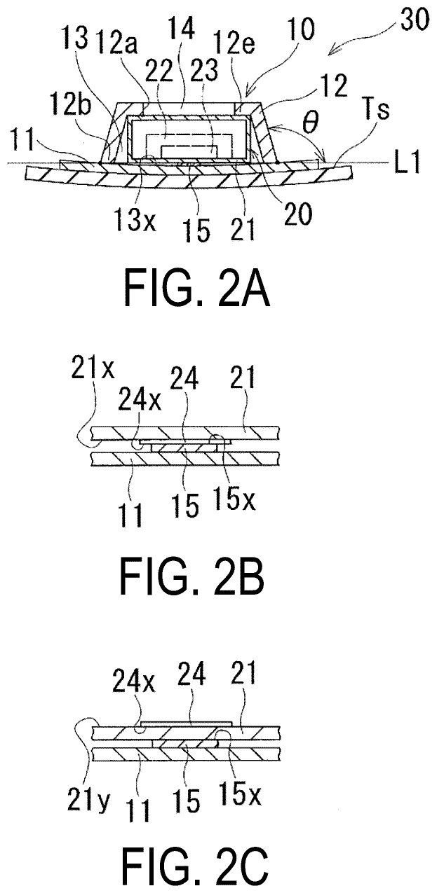

As illustrated in FIGS. 2A to 2C, the housing body 10 includes a flat plate-shaped bottom portion 11 fixed to the tire inner surface Ts, a cylindrical crown portion 12 protruding from the bottom portion 11, a housing space 13 formed by the bottom portion 11 and the crown portion 12, and an opening portion 14 communicating with the housing space 13.

The bottom portion 11 is the longest (and has the maximum diameter) among the portions constituting the housing body 10. The crown portion 12 is formed to be inclined inward from a direction orthogonal to the bottom portion 11. Accordingly, the housing space 13 formed by the bottom portion 11 and the crown portion 12 has a substantially trapezoidal cross-sectional shape. In other words, the cross-sectional width of the housing space 13 gradually decreases toward an upper portion and becomes smallest at the maximum height position. The crown portion 12 includes a locking portion 12e formed at one end 12a so as to be bent toward the opening portion 14, and an other end 12b is fixed to the bottom portion 11. After the functional component 20 is housed, the locking portion 12e is brought into contact with an upper surface of the functional component 20 and serves to fix the functional component 20 when the functional component 20 is housed. The width of the opening portion 14 into which the functional component 20 is inserted is smaller than the minimum width of the housing space 13 in a cross-sectional view (the width at a position adjacent to the opening portion 14).

At least one projection 15 is formed on an inner surface of the housing body 10. In FIGS. 2A to 2C, the projection 15 having a cylindrical shape is formed to project from the bottom portion 11 of the housing body 10. Two or more projections 15 may be formed on the bottom portion 11 of the housing body 10, or one or two or more projections 15 may be formed on another portion (for example, the crown portion 12) of the housing body 10.

In FIGS. 2A to 2C, each of the bottom portion 11, the crown portion 12, and the opening portion 14 has a circular planar shape, and the housing space 13 has a truncated cone shape. The planar shapes of the bottom portion 11, the crown portion 12, and the opening portion 14 are not limited to a particular shape and may be any other planar shape or may be planar shapes different from each other. The shape of the housing space 13 is not limited to a particular shape, either. In addition, the shape of the projection 15 is not particularly limited, and for example, even when the projection 15 is formed of a sharp point of an end portion of a cone or the like, the projection 15 can be adopted as long as the end portion can be crushed when being pressed.

As illustrated in FIG. 2A, the functional component 20 includes a housing 21 and an electronic component 22. The housing 21 has a hollow structure, and the electronic component 22 is housed therein. The electronic component 22 can include a sensor 23 configured to acquire tire information, a transmitter, a receiver, a control circuit, and a battery as appropriate. Examples of the tire information acquired by the sensor 23 include an amount of wear and the like of the tread portion 1 of the pneumatic tire. In a case where an amount of wear of the tread portion 1 is detected, a piezoelectric sensor including at least one piezoelectric element 24 can be used as the sensor 23, and the piezoelectric element 24 detects an output voltage corresponding to tire deformation during travel and detects an amount of wear of the tread portion 1 based on the output voltage. Moreover, a temperature sensor, a pressure sensor, an acceleration sensor, a magnetic sensor, or the like can be added. The functional component 20 is configured to transmit the tire information acquired by the sensor 23 to the outside of the tire. Furthermore, to easily hold the functional component 20, a knob portion protruding from an upper surface of the housing 21 may be provided, and the knob portion can have a function of an antenna.

At least one film-shaped piezoelectric element 24 is fixed to a wall surface of the housing 21 of the functional component 20. The piezoelectric element 24 can be disposed on either the outer surface or the inner surface of the housing 21. In the present technology, the projection 15 is provided at a position corresponding to the piezoelectric element 24, and has a contact surface 15x that is a contact surface on the piezoelectric element 24 side therewith. Such a piezoelectric element 24 is configured to be in contact directly or indirectly via the wall surface of the housing 21 with at least a part of the projection 15 in a state where the housing body with a functional component or the tire is in an unloaded state and the functional component 20 is housed in the housing body 10. Specifically, FIG. 2B illustrates a state where the piezoelectric element 24 is disposed on an outer surface 21x of a bottom portion of the housing 21 and the piezoelectric element 24 and the projection 15 are directly in contact with each other, and FIG. 2C illustrates a state where the piezoelectric element 24 is disposed on an inner surface 21y of the bottom portion of the housing 21 and the piezoelectric element 24 is indirectly in contact with the projection 15 via the wall surface of the housing 21. The piezoelectric element 24 includes a pressure sensing portion 24x, which is a contact surface with the projection 15, on the projection 15 side. Note that the sensor 23 and the piezoelectric element 24 are connected to each other.

In the present technology, the projection 15 is a portion for pressing the piezoelectric element 24, and the projection 15 is pressed by the functional component 20 after the functional component 20 is housed, but the bottom portion 11 of the housing body 10 is not deformed along the tire inner surface Ts. In addition, the projection 15 of the housing body 10 and the housing 21 of the functional component 20 are not fitted to each other, and a recess portion to which the projection 15 is fitted is not disposed in the bottom portion of the housing 21.

In the pneumatic tire described above, the functional component 20 includes the housing 21 containing the electronic component 22 and the film-shaped piezoelectric element 24 fixed to the wall surface of the housing 21, at least one projection 15 is formed on the inner surface of the housing body 10, and at least a part of the projection 15 and the piezoelectric element 24 are directly in contact with each other or indirectly in contact with each other via the wall surface of the housing 21 in an unloaded state and in a state where the functional component 20 is housed in the housing body 10. As a result, a pressed state of the projection 15 against the piezoelectric element 24 by vibration of the tire during travel is held, which enables stable sensing by the piezoelectric element 24. As described above, the functional component 20 can accurately acquire the tire internal information without influence by the curvature of the tire inner surface Ts or recesses/protrusions due to bladders.

In the pneumatic tire described above, the contact area between the projection 15 (contact surface 15x) and the piezoelectric element 24 (pressure sensing portion 24x) is preferably 50% or less of the area of the inner surface of the housing body 10 on which the projection 15 is formed. Here, the area of the inner surface of the housing body 10 on which the projection 15 is formed is the area of a surface 13x of the housing space 13 corresponding to the inner surface on which the projection 15 is formed, and means, for example, the area of the bottom surface of the housing space 13 in FIG. 2A. In this case, further, the contact area between the projection 15 and the piezoelectric element 24 is preferably 10% to 100% and more preferably 40% to 100% with respect to the surface area of the pressure sensing portion 24x of the piezoelectric element 24. When a plurality of projections 15 are formed on the inner surface of the housing body 10, the total contact area between the projections 15 and the piezoelectric element 24 is designed to be within the range described above. When the projection 15 is formed to have an end portion having a sharp point, for example, like a conical shape, the contact area is determined based on a contact area measured when the end portion of the projection 15 is crushed and flattened in a state where the housing body with a functional component or the tire is in an unloaded state and in a state where the functional component 20 is housed in the housing body 10.

By appropriately setting the contact area between the projection 15 and the piezoelectric element 24 as just described, the contact area between the projection 15 and the piezoelectric element 24 is sufficiently ensured, and the contact state between the projection 15 and the piezoelectric element 24 is favorably maintained, which contributes to stable sensing by the piezoelectric element 24.

The projection 15 is pressed against the piezoelectric element 24 or the wall surface of the housing 21 by elasticity of the housing body 10 after the functional component 20 is housed; however, when the contact area between the projection 15 and the piezoelectric element 24 is excessively large with respect to the surface area of the pressure sensing portion 24x of the piezoelectric element 24, pressing force due to tire rolling is dispersed to portions other than the piezoelectric element 24, and the sensing output by the piezoelectric element 24 may be decreased. On the other hand, when the contact area between the projection 15 and the piezoelectric element 24 is excessively small with respect to the surface area of the pressure sensing portion 24x of the piezoelectric element 24, a load is locally applied to the piezoelectric element 24. As a result, the durability of the piezoelectric element 24 may be deteriorated undesirably.

A height t of the projection 15 is preferably 0.1 mm to 2.0 mm, and more preferably 0.5 mm to 1.0 mm. Here, the height t of the projection 15 is a height from the inner surface (for example, an end surface of the bottom portion 11 of the housing body 10 in FIG. 2A) of the housing body 10 on which the projection 15 is formed, and is measured in a state where the functional component 20 is not housed in the housing body 10. By appropriately setting the height t of the projection 15 as just described, the contact state between the projection 15 and the piezoelectric element 24 can be appropriately maintained. In addition, the functional component 20 can be prevented from falling off during travel without influence on an operation for housing the functional component 20 in the housing body 10.

Here, when the height t of the projection 15 is smaller than 0.1 mm, the effect of improving the contact state with the piezoelectric element 24 cannot be sufficiently obtained. On the other hand, when the height t of the projection 15 is larger than 2.0 mm, it is difficult to house the functional component 20 in the housing body 10, and the risk of falling off of the functional component 20 during travel increases.

The projection 15 is preferably made of vulcanized rubber having a modulus at 100% elongation of 1.0 MPa or more and less than 12.0 MPa. The projection 15 includes such physical properties, and thus the durability of the housing body 10 and ease of housing the functional component 20 in the housing body 10 can be provided in a compatible manner. In addition, the projection 15 can be made of the same material as the housing body 10. For example, the projection 15 may be integrally formed from rubber having hardness different from that of the housing body 10 by using a mold for forming the housing body 10, or the projection 15 formed separately from the housing body 10 may be bonded to the inner surface of the housing body 10.

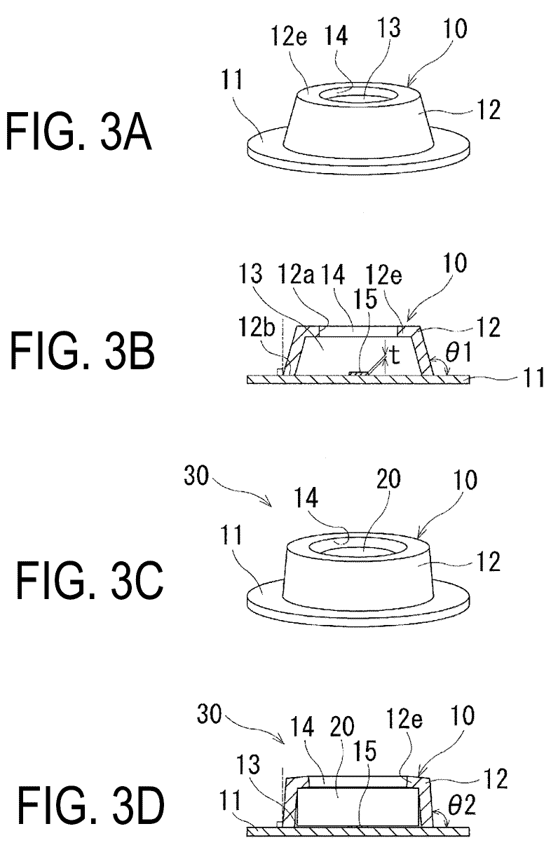

FIGS. 3A to 3D illustrate an embodiment of the housing body with a functional component before and after the functional component is housed. The housing body with a functional component 30 in FIGS. 3A and 3B is in a state where the functional component 20 is not housed in the housing body 10, and the housing body with a functional component 30 in FIGS. 3C and 3D is in a state where the functional component 20 is housed in the housing body 10.

As illustrated in FIGS. 3A to 3D, in the housing body with a functional component 30, an inclination angle θ2 of the crown portion 12 with respect to the bottom portion 11 in a state where the functional component 20 is housed in the housing space 13 is configured to be smaller than an inclination angle θ1 of the crown portion 12 with respect to the bottom portion 11 in a state where the functional component 20 is not housed in the housing space 13. Each of the inclination angles θ1, θ2 is an angle measured on the outer wall side of the crown portion 12. When the functional component 20 is housed in the housing space 13 from the opening portion 14, the crown portion 12 flexes toward the outer side and deforms so as to expand the width of the opening portion 14, and thus the inclination angle θ of the crown portion 12 with respect to the bottom portion 11 decreases. The angle difference (θ1−θ2) between the inclination angle θ1 before the functional component 20 is housed and the inclination angle θ2 after the functional component 20 is housed is preferably configured to be in the range of 5° to 15°.

Here, in measuring the inclination angle θ (θ1, θ2) of the crown portion 12, the angle can be calculated by using a CT scan or the like. Here, as illustrated in FIG. 2A, when the inclination angles θ1, θ2 are measured, an angle formed by a straight line L1 passing through an other end 12b of both sides of the crown portion 12 in a cross-sectional view and the crown portion 12 is measured. For example, even a housing body with a functional component that is not provided with a member corresponding to a bottom portion and is provided with a crown portion directly fixed to the tire inner surface can be measured by the same method as described above.

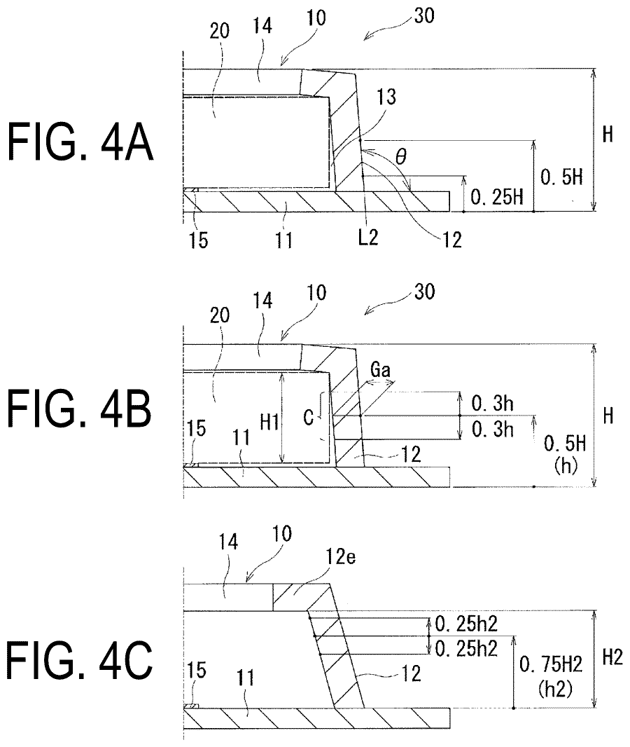

Further, only in measuring the inclination angle θ of the crown portion 12, as illustrated in FIG. 4A, the inclination angle θ1 before the functional component 20 is housed and the inclination angle θ2 after the functional component 20 is housed are respectively measured by regarding, as the crown portion 12, a straight line L2 passing through two points corresponding to one half of a total height H (0.5×H) and one quarter of the total height H (0.25×H) of the housing body 10 on the outer surface of the crown portion 12. The total height H (maximum height H) of the housing body 10 changes before and after the functional component 20 is housed, and the inclination angle θ (θ1, θ2) of the crown portion 12 is measured based on each height. Furthermore, when a projection portion is formed on the outer surface of the crown portion 12 at the position corresponding to one half and/or one quarter of the total height H of the housing body 10, the inclination angle θ of the crown portion 12 is measured based on a straight line defined by using a lower end portion of the projection portion as a new reference point without including the projection portion. The total height H of the housing body 10 is a height from a lower surface of the bottom portion 11 to an upper surface of the locking portion 12e.

The housing body with a functional component 30 as just described is configured such that the housing body 10 includes the bottom portion 11 fixed to the tire inner surface Ts, the crown portion 12 protruding from the bottom portion 11, the housing space 13 formed by the bottom portion 11 and the crown portion 12, and the opening portion 14 communicating with the housing space 13, the inclination angle θ2 of the crown portion 12 with respect to the bottom portion 11, measured on the outer wall side of the crown portion 12 in a state where the functional component 20 is housed in the housing space 13 is smaller than the inclination angle θ1 of the crown portion 12 with respect to the bottom portion 11, measured on the outer wall side of the crown portion 12 in a state where the functional component 20 is not housed in the housing space 13. Thus, in the housing body 10 housing the functional component 20, excessive deformation of the housing body 10 can be prevented while ensuring the restricting force by which the functional component 20 can be sufficiently restricted. In particular, when the angle difference (θ1−θ2) between the inclination angles before and after the functional component 20 is housed is in the range of 5° to 15°, the restricting force of the housing body 10 with respect to the functional component 20 and the degree of deformation at which the housing body 10 is not damaged is extremely well-balanced. This can prevent the damage of the housing body 10 while preventing the functional component 20 from coming off during travel.

Here, when the angle difference (θ1−θ2) of the inclination angles is smaller than 5°, the restricting force of the housing body 10 with respect to the functional component 20 is reduced. As a result, the risk of coming off of the functional component 20 during travel increases and the motion of the functional component 20 increases, and thus the durability of the housing body 10 is reduced. On the other hand, when the angle difference (θ1−θ2) between the inclination angles is larger than 15°, the deformation of the housing body 10 becomes excessively large, and cracks are likely to occur in the housing body 10 during long-distance travel.

In particular, the inclination angle θ2 of the crown portion 12 with respect to the bottom portion 11 in a state where the functional component 20 is housed in the housing space 13 is preferably 90° or more and more preferably in the range of 90° to 115°. By appropriately setting the inclination angle θ2 after the functional component 20 is housed as just described, stress concentration at the base of the crown portion 12 of the housing body 10 can be mitigated, and the durability of the housing body 10 can be improved. Furthermore, the opening portion 14 of the housing body 10 is not excessively narrow, which is suitable in removing the functional component 20.

Here, when the inclination angle θ2 after the functional component 20 is housed is smaller than 90°, stress concentration at the base of the crown portion 12 of the housing body 10 increases, and strain energy during travel increases. As a result, cracks are likely to occur at the base of the crown portion 12. On the other hand, when the inclination angle θ2 after the functional component 20 is housed is larger than 115°, the crown portion 12 is excessively flexed even after the functional component 20 is housed. This makes the width of the opening portion 14 excessively narrow and makes it difficult to remove the functional component 20.

In a state where the functional component 20 is housed in the housing space 13, the crown portion 12 preferably has a thickness Ga of 1.0 mm to 3.5 mm. Here, as illustrated in FIG. 4B, a half height of the total height H of the housing body 10 after the functional component 20 is housed is h, and the range of ±30% of the height h (0.3×h) with reference to the position (center position) of the height h is a central range C. At this time, in the entire central range C, the thickness Ga of the crown portion 12 measured in a horizontal direction is preferably in the range of 1.0 mm to 3.5 mm.

By appropriately setting the thickness Ga of the crown portion 12 as just described, the occurrence of cracks in the crown portion 12 of the housing body 10 can suppressed, and the durability of the housing body 10 can be improved. Furthermore, when the thickness Ga of the crown portion 12 of the housing body 10 is excessively large, the heat generation of the housing body 10 increases. However, when the thickness Ga is within the range described above, the heat generation of the housing body 10 can be suppressed, and damage of the housing 21 of the functional component 20 can be prevented.

Here, when the thickness Ga of the crown portion 12 is less than 1.0 mm, the thickness Ga of the crown portion 12 is excessively small, and cracks are likely to occur in the crown portion 12. On the other hand, when the thickness Ga of the crown portion 12 is larger than 3.5 mm, the heat generation of the housing body 10 (for example, rubber) increases, and the housing 21 of the functional component 20 is likely to be damaged.

The end 12a of the crown portion 12 includes the locking portion 12e bent toward the opening portion 14, and the height H1 of the functional component 20 and the total inner height H2 of the housing body 10 satisfy the relationship 0.85≤H2/H1≤0.98. Here, as illustrated in FIG. 4B, the height H1 of the functional component 20 is the maximum height within a range in which the functional component 20 is housed in the housing body 10 after the functional component 20 is housed, that is, the maximum height of the functional component 20 in the housing space 13. This means that when, for example, a knob portion disposed on an upper portion of the functional component 20 protrudes from the housing space 13, the height H1 of the functional component 20 does not include the height of a portion of the knob portion outside the housing space 13. The total inner height H2 of the housing body 10 is a height from an upper surface of the bottom portion 11 to a lower surface of the locking portion 12e before the functional component 20 is housed.

By appropriately setting the height H1 of the functional component 20 and the total inner height H2 of the housing body 10 as just described, a good balance between the restricting force of the housing body 10 with respect to the functional component 20 and the degree of deformation at which the housing body 10 is not damaged can be provided, and the durability of the functional component 20 during high-speed travel can be improved.

Here, when the ratio H2/H1 is less than 0.85, the locking portion 12e cannot house the functional component 20 so as to cover the functional component 20, and thus the effect of improving the durability of the functional component 20 during high-speed travel is reduced. On the other hand, when the ratio H2/H1 is larger than 0.98, the restricting force of the housing body 10 decreases, and the motion of the functional component 20 in the housing body 10 increases. As a result, the effect of improving the durability of the functional component 20 during high-speed travel cannot be obtained.

The width of the opening portion 14 is preferably smaller than the minimum width of the housing space 13, and a circumferential length D2ᵤ of the upper portion of the housing space 13 and a circumferential length D1ᵤ of an upper portion of the functional component 20 preferably satisfy the relationship 0.60≤D2ᵤ/D1ᵤ≤0.95. In other words, the circumferential length D2ᵤ of the housing space 13 is set to be smaller than the circumferential length D1ᵤ of the functional component 20 within a specific range, and it is thereby intended to increase restricting force by the housing body 10. Here, as illustrated in FIG. 4C, the circumferential length D2ᵤ of the housing space 13 is obtained by defining a height of three quarters of the total inner height H2 (0.75×H2) of the housing body 10 as h2 before the functional component 20 is housed, measuring the circumferential length of the housing space 13 at a total of three positions including the position of the height h2 and the positions corresponding to ±25% of the height h2 (0.25×h2) with reference to the position of the height h2, and averaging the circumferential lengths measured at these three positions. The circumferential length D1ᵤ of the upper portion of the functional component 20 is obtained by measuring the circumferential length of the functional component 20 at positions corresponding to the aforementioned three positions of the functional component 20 and averaging the circumferential lengths measured at these three positions.

By appropriately setting the circumferential length D2ᵤ of the housing space 13 and the circumferential length D1ᵤ of the functional component 20 as just described, the restricting force of the housing body 10 with respect to the functional component 20 can be increased, and the motion of the functional component 20 can be suppressed. Thus, the housing 21 of the functional component 20 can be prevented from being damaged during high-speed travel. In addition, a good balance between the restricting force of the housing body 10 with respect to the functional component 20 and the degree of deformation at which the housing body 10 is not damaged is provided, and thus damage of the housing body 10 can also be prevented.

Here, when the ratio D2ᵤ/D1ᵤ is less than 0.60, the degree of deformation of the crown portion 12 also increases though the restricting force by the housing body 10 increases. As a result, cracks are generated in the housing body 10 during long-distance travel, and the possibility of damage of the housing body 10 increases. On the other hand, when the ratio D2ᵤ/D1ᵤ is larger than 0.95, the restricting force by the housing body 10 decreases, and the motion of the functional component 20 in the housing body 10 increases. This increases heat generation due to friction between the housing body 10 and the functional component 20, resulting in damage of the housing 21 of the functional component 20.

Further, a circumferential length D2_{O} of the opening portion 14 of the housing body 10 and the circumferential length D1ᵤ of the upper portion of the functional component 20 preferably satisfy the relationship 0.4≤D2_{O}/D1ᵤ≤0.8. Here, the circumferential length D2_{O} of the opening portion 14 is a circumferential length of the opening portion 14 measured in a state where the functional component 20 is not housed in the housing body 10. By appropriately setting the circumferential length D2_{O} of the opening portion 14 and the circumferential length D1ᵤ of the functional component 20 as just described, a good balance between the restricting force of the housing body 10 with respect to the functional component 20 and the degree of deformation at which the housing body 10 is not damaged can be provided, and the durability of the functional component 20 during high-speed travel can be improved. Furthermore, the opening portion 14 of the housing body 10 is not excessively narrow, which is suitable in removing the functional component 20.

Here, when the ratio D2_{O}/D1ᵤ is less than 0.4, the opening portion 14 is excessively narrow, and thus it becomes difficult to remove the functional component 20. On the other hand, when the ratio D2_{O}/D1ᵤ is larger than 0.8, the restricting force by the housing body 10 decreases, and the motion of the functional component 20 in the housing body 10 increases. This increases heat generation due to friction between the housing body 10 and the functional component 20, resulting in damage of the housing 21 of the functional component 20.

In addition, the housing body 10 can be made of rubber, elastomer, resin, or the like. In particular, the constituent material of the housing body 10 preferably has the following physical properties. The modulus of the housing body 10 at 100% elongation at 20° C. is preferably 0.5 MPa or more and less than 10.0 MPa, and the loss modulus of the housing body 10 at 60° C. is preferably 0.4 MPa or more and less than 20.0 MPa. By appropriately setting the modulus as just described, the durability of the housing body 10 and ease of housing the functional component 20 in the housing body 10 can be provided in a compatible manner. By appropriately setting the loss modulus as just described, the housing 21 of the functional component 20 can be prevented from being damaged due to rubbing of the functional component 20 against the housing body 10 or repeated deformation of the housing body 10.

In the aforementioned embodiment, an example in which the housing body with a functional component is attached to the pneumatic tire is described but no such limitation is intended, and the housing body with a functional component can be applied to a non-pneumatic tire.

### Examples

Tires of Conventional Example, Comparative Examples 1 and 2, and Examples 1 to 4 were manufactured. Each of the tires has a tire size of 225/45ZR18 and includes a functional component configured to acquire tire information and a rubber housing body adapted to house the functional component. In a pneumatic tire having a tire inner surface to which the housing body housing the functional component is fixed, the functional component includes a housing containing an electronic component and a film-shaped piezoelectric element fixed to a wall surface of the housing. In each tire, the presence of the projection, the diameter d of the projection, the height t of the projection, the position a of the projection, the ratio of the contact area of the projection to the area of the inner surface of the housing body on which the projection is formed, the ratio of the contact area of the projection to the surface area of a pressure sensing portion of the piezoelectric element, and M100 of the projection were set as indicated in Table 1.

In each test tire, the piezoelectric element disposed in the housing of the functional component has a circular shape with a diameter d1 of 10 mm, and is disposed in the central portion of the housing of the functional component. In addition, the bottom surface of the inner portion of the housing body has a circular shape with a diameter d2 of 20 mm. Moreover, in the tires of Comparative Examples 1 and 2 and Examples 1 to 4, the projection disposed in the housing body has a cylindrical shape.

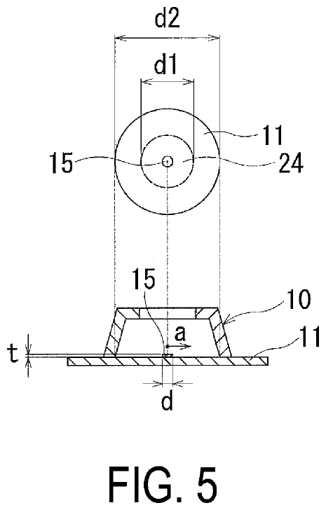

In Table 1, “position a of projection” means a distance (mm) from the center of the housing body to the center of the projection as illustrated in FIG. 5. “M100 of the projection” means the modulus at 100% elongation (MPa), is measured in a tensile test at 23° C. in conformance with JIS (Japanese Industrial Standard) K6251 (using a dumbbell No. 3), and indicates tensile stress at 100% elongation.

For these test tires, sensing intensity and presence of falling off of the functional component were evaluated by the following test methods, and the results are shown in Table 1.

### Sensing Intensity:

Each of the test tires was mounted on a wheel having a rim size of 18×7.5J, a 60% load of the maximum load capacity was applied, and a running test was performed on the tire using a drum testing machine under air pressure of 230 kPa, at travel speed of 30 km/h, with distance traveled of 2.5 km. Specifically, ten tires were used for each test tire, strain of the inner surface of the tire was measured by the piezoelectric element, and the measured strain values were averaged. Evaluation results are expressed as index values with the measurement value of Conventional Example being defined as 100. Larger index values indicate superior sensing intensity.

### Presence of Falling Off of Functional Component:

Each of the test tires was mounted on a wheel having a rim size of 18×7.5J, an 80% load of the maximum load capacity was applied, and a running test was performed on the tire using a drum testing machine under air pressure of 540 kPa, at travel speed of 81 km/h, and with distance traveled of 20000 km. Thereafter, the presence of falling off of the functional component was visually confirmed. The evaluation results indicated the presence of falling off of the functional component.

TABLE 1

| | Conventional | Comparative | Comparative |
|---|---|---|---|
| | Example | Example 1 | Example 2 |
| Presence of projection | No | Yes | Yes |
| Diameter d (mm) of projection | — | 2.0 | 2.0 |
| Projection height t (mm) | — | 2.5 | 1.0 |
| Position a of projection (mm) | — | 6.0 | 6.0 |
| Ratio (%) of contact area of | — | 1 | 1 |
| projection to area of inner surface | | | |
| of housing body on which | | | |
| projection is formed | | | |
| Ratio (%) of contact area of | — | 4 | 4 |
| projection to surface area of | | | |
| pressure sensing portion of | | | |
| piezoelectric element | | | |
| M100 of projection (MPa) | — | 1.6 | 1.6 |
| Sensing intensity | 100 | 50 | 60 |
| Presence of falling off of functional | No | Yes | No |
| component | | | |

| | Example | Example | Example | Example |
|---|---|---|---|---|
| | 1 | 2 | 3 | 4 |
| Presence of projection | Yes | Yes | Yes | Yes |
| Diameter d (mm) of projection | 2.0 | 8.0 | 8.0 | 8.0 |
| Projection height t (mm) | 1.0 | 1.0 | 0.5 | 0.5 |
| Position a of projection (mm) | 0 | 0 | 0 | 0 |
| Ratio (%) of contact area of projection to | 1 | 16 | 16 | 16 |
| area of inner surface of housing body on | | | | |
| which projection is formed | | | | |
| Ratio (%) of contact area of projection to | 4 | 64 | 64 | 64 |
| surface area of pressure sensing portion | | | | |
| of piezoelectric element | | | | |
| M100 of projection (MPa) | 1.6 | 1.6 | 1.6 | 10.1 |
| Sensing intensity | 130 | 150 | 180 | 200 |
| Presence of falling off of functional | No | No | No | No |
| component | | | | |

As can be seen from Table 1, the pneumatic tires of Examples 1 to 4 have improved sensing intensity and have no presence of falling off of the functional component as compared with Conventional Example. In the pneumatic tires of Examples 1 to 4, it was confirmed that the effect of improving sensing intensity could be sufficiently obtained and that the tire internal information could be accurately acquired.

On the other hand, in each of Comparative Examples 1 and 2, since the projection of the housing body was disposed away from the piezoelectric element of the functional component and the projection and the piezoelectric element were not in contact with each other at all, sensing intensity was deteriorated. Additionally, in Comparative Example 1, since the height of the projection of the housing body was excessively large, the functional component fell off.

1. A housing body with a functional component, comprising:
a functional component configured to acquire tire information; and
a housing body adapted to house the functional component,
the functional component comprising a housing containing an electronic component, and a piezoelectric element having a film-shape and being fixed to a wall surface of the housing,
at least one projection being formed on an inner surface of the housing body, and at least a part of the projection and the piezoelectric element being directly in contact with each other or indirectly in contact with each other via the wall surface of the housing in an unloaded state and in a state where the functional component is housed in the housing body.

2. The housing body with a functional component according to claim 1, wherein a contact area between the projection and the piezoelectric element is 50% or less with respect to an area of the inner surface of the housing body on which the projection is formed, and is 10% to 100% with respect to a surface area of a pressure sensing portion of the piezoelectric element.

3. The housing body with a functional component according to claim 1, wherein a height of the projection from the inner surface of the housing body on which the projection is formed is 0.1 mm to 2.0 mm.

4. The housing body with a functional component according to claim 1, wherein the projection is made of vulcanized rubber having a modulus at 100% elongation of 1.0 MPa or more and less than 12.0 MPa.

5. The housing body with a functional component according to claim 1, wherein
the housing body comprises a bottom portion fixed to a tire inner surface, a crown portion protruding from the bottom portion, a housing space formed by the bottom portion and the crown portion, and an opening portion communicating with the housing space,
an inclination angle of the crown portion with respect to the bottom portion measured on an outer wall side of the crown portion in a state where the functional component is housed in the housing space is smaller than an inclination angle of the crown portion with respect to the bottom portion measured on the outer wall side of the crown portion in a state where the functional component is not housed in the housing space, and
an angle difference between the inclination angles is in a range of 5° to 15°.

6. The housing body with a functional component according to claim 5, wherein the inclination angle of the crown portion with respect to the bottom portion measured on the outer wall side of the crown portion in a state where the functional component is housed in the housing space is 90° or more.

7. The housing body with a functional component according to claim 5, wherein a thickness Ga of the crown portion in a state where the functional component is housed in the housing body is 1.0 mm to 3.5 mm.

8. The housing body with a functional component according to claim 5, wherein a width of the opening portion is smaller than a minimum width of the housing space, and a circumferential length D2ᵤ of an upper portion of the housing space and a circumferential length D1ᵤ of an upper portion of the functional component satisfy a relationship 0.60≤D2ᵤ/D1ᵤ≤0.95.

9. The housing body with a functional component according to claim 5, wherein
an end portion of the crown portion comprises a locking portion bent toward the opening portion, and
a height H1 of the functional component and a total inner height H2 of the housing body satisfy a relationship 0.85≤H2/H1≤0.98.

10. The housing body with a functional component according to claim 5, wherein a circumferential length D2_{O} of the opening portion of the housing body and a circumferential length D1ᵤ of an upper portion of the functional component satisfy a relationship 0.4≤D2_{O}/D1ᵤ≤0.8.

11. The housing body with a functional component according to claim 1, wherein
a modulus of the housing body at 100% elongation at 20° C. is 0.5 MPa or more and less than 10.0 MPa, and
a loss modulus of the housing body at 60° C. is 0.4 MPa or more and less than 20.0 MPa.

12. The housing body with a functional component according to claim 1, wherein the housing body is made of vulcanized rubber.

13. The housing body with a functional component according to claim 1, wherein the housing body is fixed to a tire inner surface with an adhesive.

14. A tire, comprising:
the housing body with a functional component according to claim 1 fixed to a tire inner surface, the functional component being housed in the housing body.
